(19) United States
(12) Patent Application Publication
(10) Pub. No.: US 2024/0410511 A1
(43) Pub. Date: Dec. 12, 2024

(54) System and Method for Inducing Vibration to Prevent or Reduce Obstruction Formation

(71) Applicant: Applied Ultrasonics International Pty Ltd, Charlestown (AU)

(72) Inventors: Peter J. Simons, Warriewood (AU); Samuel Abston, Alabaster, AL (US)

(21) Appl. No.: 18/614,646

(22) Filed: Mar. 23, 2024

Related U.S. Application Data
(60) Provisional application No. 63/454,690, filed on Mar. 26, 2023.

(51) Int. Cl. F16L 55/24

(52) U.S. Cl. CPC F16L 55/24

(57) ABSTRACT

Representative embodiments of a system and method of reducing obstruction formation in a pipe, pipeline, or other container are disclosed. A representative system includes: a plurality of transducers and a controller, with the controller including a memory circuit configured to store a plurality of operational parameters; and a processor circuit configured to control energizing of the plurality of transducers in response to the plurality of operational parameters. Representative systems may also include a coupling ring or a coupling stub coupled to the transducers and coupleable to the pipe or workpiece. The operational parameters may include a frequency or frequency range, a location, a selection of transducers, and an ordering, mode, and duration or time period of energizing the selected transducers. In a representative embodiment, the transducers are operable in an ultrasonic frequency range.

### CROSS-REFERENCE TO A RELATED APPLICATION

This application is a nonprovisional of and claims priority to and the benefit of U.S. Provisional Patent Application No. 63/454,690, filed Mar. 26, 2023, any and all of which is hereby incorporated herein by reference in its entirety with the same full force and effect as if set forth in its entirety herein.

### FIELD OF THE INVENTION

The present invention, in general, relates to creating vibration in pipes, pipelines, holding tanks, and other containers, and more particularly, relates to a system and method for inducing vibration at ultrasonic or other frequencies in pipes, pipelines, holding tanks, valves, or other containers, to prevent or reduce obstruction formation.

### BACKGROUND OF THE INVENTION

In many industries, pipes, pipelines, or piping systems are utilized to transport liquid substances having particulate matter, typically as a pumpable slurry. For example, different types of refining, such as aluminum refining, may include transporting a granulated or particulate ore or intermediate product, such as a pulverized bauxite ore, as a slurry flowing in a pipe or pipeline. One of the difficulties associated with this transport of such a slurry is the tendency for particles to settle out of the slurry and collect at the lower or bottom surface of the interior lumen of the pipe or pipeline or at other locations within the lumen of the pipe, pipeline or other container or vessel, creating an obstruction and impeding the flow of the slurry, and eventually clogging the pipe or otherwise significantly obstructing and reducing the slurry flow through the pipe. These settling, flow reduction and obstruction problems are especially acute at an elbow or other bend or turn in the pipe or pipeline, and at pipe valve locations, which often creates a turbulent flow having eddies, increasing the settling out of the suspended particles of the slurry. These settling, flow reduction and obstruction issues also arise in holding tanks, pipe valves, other containers, etc.

Current methods of remediating these reduced flow and obstruction problems are largely mechanical or chemical, and do not prevent the initial settling and buildup of the obstruction or clog. Typically, production is halted, the obstructed pipe, pipeline, or tank is drained, and a caustic substance or high pressure or high temperature fluid is flowed through the pipe, pipeline, or tank in an attempt to dissolve the particulate obstruction or clog. In other circumstances, production is also halted, the pipe or pipeline is disassembled, with the obstructed portion of the pipe being physically removed, followed by reassembling the pipe or pipeline by installing a new pipe section to replace the obstructed portion.

As a consequence, a need remains for a system and method to reduce settling of particles in a flowing slurry, to reduce or eliminate obstruction formation in pipes, pipelines, holding tanks, pipe valves, or other containers. Such a system and method should be capable of operating during the flow of the slurry without requiring the interruption or halting of the production process, and without requiring the introduction of caustic chemicals into the pipe, pipeline, holding tank, pipe valve, other container. Such a system and method also should be capable of installation and operation in existing commercial facilities.

### SUMMARY OF THE INVENTION

The exemplary or representative embodiments of the present invention provide numerous advantages. Various representative embodiments provide a vibrational system and method to reduce settling of particles in a flowing slurry, thereby reducing or eliminating the obstruction of the pipes, pipelines, holding tanks, pipe valves, other containers. The representative embodiments of the vibrational system are capable of operating during the flow of the slurry without requiring interruption or halting of the production process, and without requiring the introduction of caustic chemicals into the pipe, pipeline, holding tank, pipe valve, or other container. The representative embodiments of the vibrational system also are capable of installation and operation in existing commercial facilities.

In a representative embodiment, a system is disclosed for coupling to a pipe, pipeline, vessel, or other workpiece, with the system comprising: a plurality of transducers; a coupling ring coupled to the plurality of transducers and coupleable to the pipe, pipeline, vessel, or other workpiece; and a controller coupled to the plurality of transducers, the controller comprising: a memory circuit configured to store a plurality of operational parameters; and a processor circuit coupled to the memory circuit, the processor circuit configured to control energizing of the plurality of transducers in response to the plurality of operational parameters.

In another representative embodiment, a system comprises: a plurality of transducers; a coupling stub coupled to the plurality of transducers and coupleable to the pipe, pipeline, vessel, or other workpiece; and a controller coupled to the plurality of transducers, the controller comprising: a memory circuit configured to store a plurality of operational parameters; and a processor circuit coupled to the memory circuit, the processor circuit configured to control energizing of the plurality of transducers in response to the plurality of operational parameters.

In another representative embodiment, a system comprises: a plurality of transducers coupleable to a pipe, pipeline, vessel, or other workpiece; and a controller coupled to the plurality of transducers, the controller comprising: a memory circuit configured to store a plurality of operational parameters; and a processor circuit coupled to the memory circuit, the processor circuit configured to control energizing of the plurality of transducers in response to the plurality of operational parameters.

A method is also disclosed for reducing obstruction formation in a pipe, pipeline, holding tank, valve, or other container, using a plurality of transducers coupled to the pipe, pipeline, holding tank, valve, or other container, with the method comprising: selecting one or more operational parameters of a plurality of operational parameters; and energizing one or more transducers of the plurality of transducers in response to the selected operational parameters.

In a representative embodiment, the plurality of transducers are each operable in an ultrasonic frequency range greater than or equal to 20 kHz. For example, the plurality of transducers may be operable in an ultrasonic frequency range from 1 kHz to 20 MHz.

In various representative embodiments: a first operational parameter of the plurality of operational parameters may comprise a frequency or frequency range; a second operational parameter of the plurality of operational parameters may comprise a location of the plurality of transducers; a third operational parameter of the plurality of operational parameters may comprise a selection of one or more transducers of the plurality of transducers; a fourth operational parameter of the plurality of operational parameters may comprise an ordering of energizing of the plurality of transducers; a fifth operational parameter of the plurality of operational parameters may comprise a mode of energizing of the plurality of transducers; and a sixth operational parameter of the plurality of operational parameters may comprise a duration or time period of energizing of the plurality of transducers. Stated another way, the plurality of operational parameters comprises at least two operational parameters selected from the group consisting of: a frequency or frequency range; a location of the plurality of transducers; a selection of one or more transducers of the plurality of transducers; a sequential ordering of energizing of the plurality of transducers; a random or pseudo-random ordering of energizing of the plurality of transducers; a non-sequential ordering of energizing of the plurality of transducers; a continuous mode of energizing of the plurality of transducers; a pulsed mode of energizing of the plurality of transducers; a duration or time period of energizing of the plurality of transducers; and combinations thereof.

For example, the ordering of the energizing of the plurality of transducers may comprise one or more orderings selected from the group consisting of: a sequential ordering, a random or pseudo-random ordering, a non-sequential ordering, and combinations thereof. Also for example, the mode of the energizing of the plurality of transducers may comprise one or more modes selected from the group consisting of: continuous energizing, pulsed energizing, and combinations thereof.

In a representative embodiment, one or more transducers of the plurality of transducers may comprise a transducer selected from the group consisting of: a magnetoresistive transducer, a piezoelectric transducer, a mutual induction transducer, an electromagnetic transducer, a Hall Effect transducer; and combinations thereof.

For example, a method is provided for reducing obstruction formation in a pipe, pipeline, holding tank, valve, or other container, using a plurality of transducers coupled to the pipe, pipeline, holding tank, valve, or other container, with the method comprising: selecting a location of one or more transducers of the plurality of transducers for energizing; selecting one or more transducers of the plurality of transducers for energizing at the selected location; selecting an ordering of energizing of the selected one or more transducers at the selected location; selecting a mode of energizing of the selected one or more transducers at the selected location; selecting a frequency or frequency range of energizing of the selected one or more transducers at the selected location; selecting duration of energizing of the selected one or more transducers at the selected location; and energizing the one or more transducers at the selected location according to the selected order, mode, frequency or frequency range, and duration.

Numerous other advantages and features of the present invention will become readily apparent from the following detailed description of the invention and the embodiments thereof, from the claims and from the accompanying drawings.

### BRIEF DESCRIPTION OF THE DRAWINGS

The objects, features and advantages of the present invention will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 is an isometric view and electronic block diagram illustrating a representative first embodiment of a vibrational system.

FIG. 2 is a partial cross-sectional view (through the A-A′ plane) of the representative first embodiment of the vibrational system of FIG. 1.

FIG. 3 is an isometric, cut-away view and electronic block diagram illustrating a representative second embodiment of a vibrational system.

FIG. 4 is an isometric view and electronic block diagram illustrating a representative third embodiment of a vibrational system.

FIG. 5 is a cut-away, plan view illustrating a representative embodiment of an ultrasonic transducer.

FIG. 6 is a flow chart illustrating a method of providing vibration.

FIG. 7 is an electronic block diagram illustrating a representative embodiment of a controller of the representative first, second, or third embodiments of the vibrational system.

### DETAILED DESCRIPTION OF REPRESENTATIVE EMBODIMENTS

While the present invention is susceptible of embodiment in many different forms, there are shown in the drawings and will be described herein in detail specific exemplary embodiments thereof, with the understanding that the present disclosure is to be considered as an exemplification of the principles of the invention and is not intended to limit the invention to the specific embodiments illustrated. In this respect, before explaining at least one embodiment consistent with the present invention in detail, it is to be understood that the invention is not limited in its application to the details of construction and to the arrangements of components set forth above and below, illustrated in the drawings, or as described in the examples. Methods and apparatuses consistent with the present invention are capable of other embodiments and of being practiced and carried out in various ways. Also, it is to be understood that the phraseology and terminology employed herein, as well as the abstract included below, are for the purposes of description and should not be regarded as limiting.

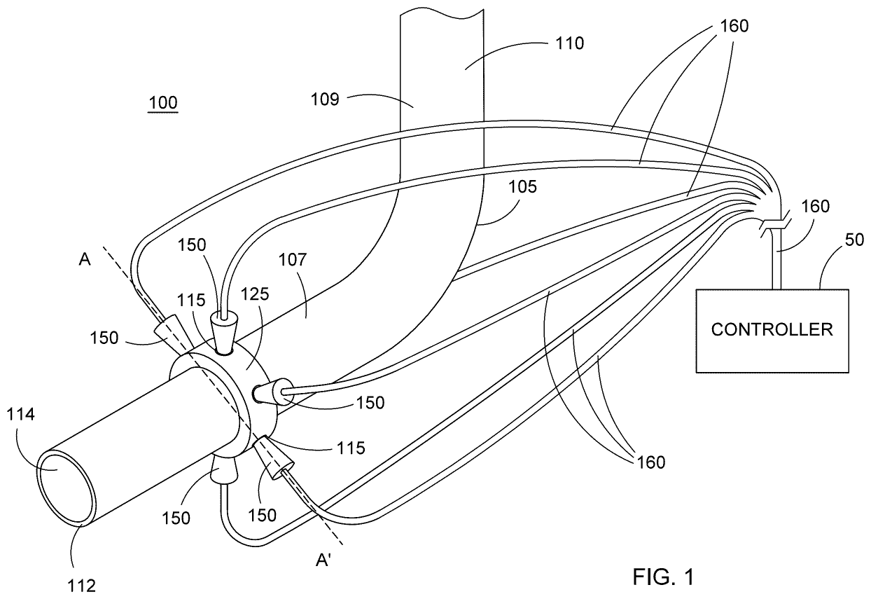

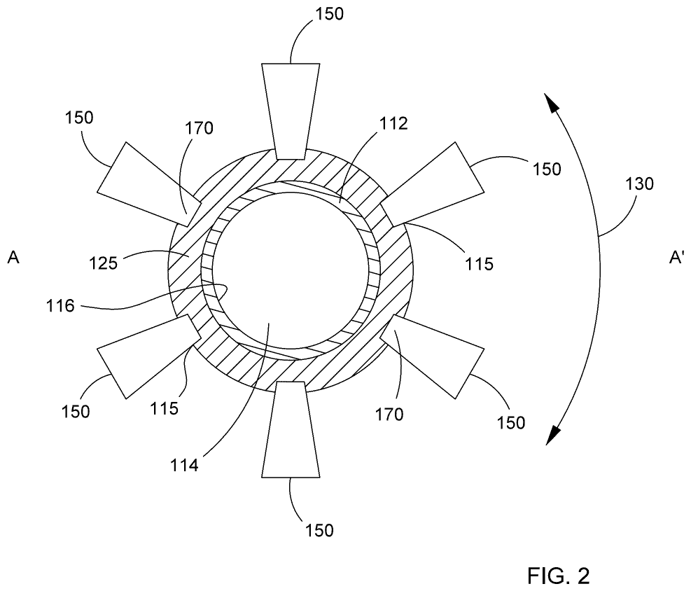

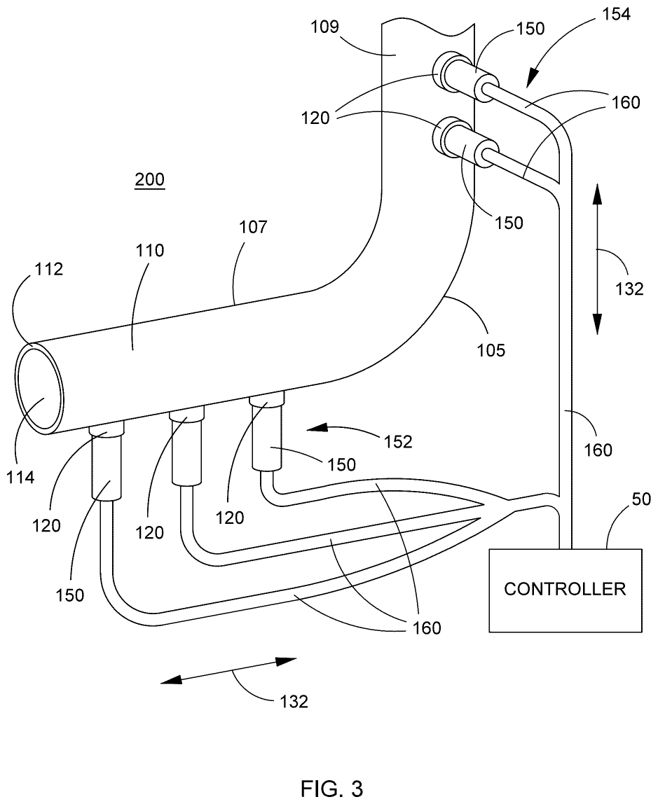

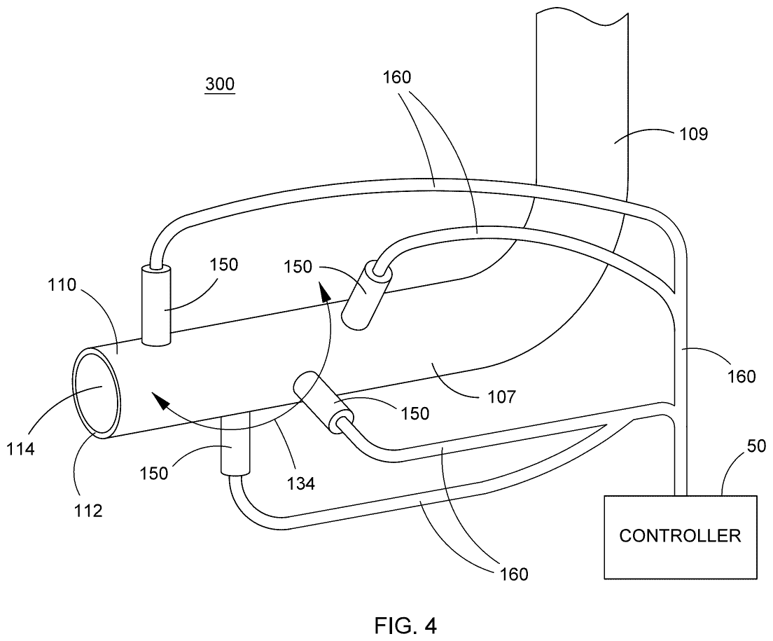

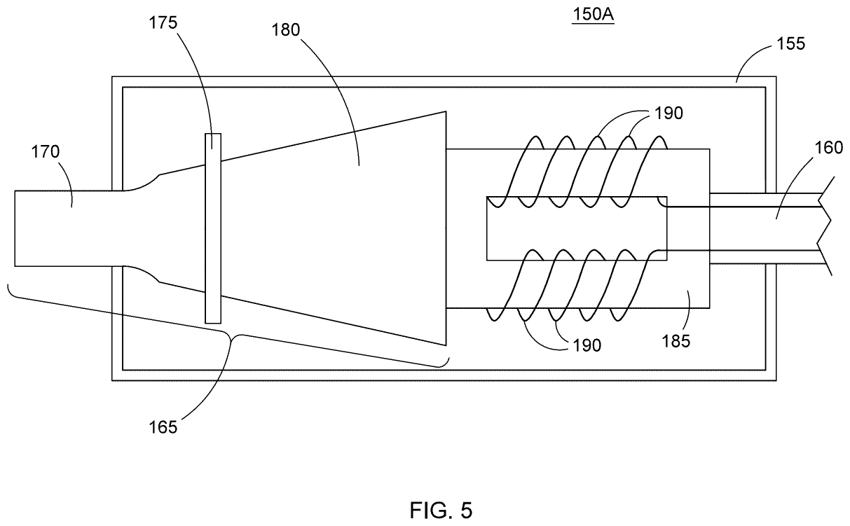

FIG. 1 is an isometric view and electronic block diagram illustrating a representative first embodiment of a vibrational system 100. FIG. 2 is a partial, cross-sectional view (through the A-A′ plane) of the representative first embodiment of the vibrational system 100 of FIG. 1, in which the illustrated power cables 160 of FIG. 1 have been omitted for case of visualization. FIG. 3 is an isometric, cut-away view and electronic block diagram illustrating a representative second embodiment of a vibrational system 200. FIG. 4 is an isometric view and electronic block diagram illustrating a representative third embodiment of a vibrational system 300. FIG. 5 is a cut-away, plan view illustrating a representative embodiment of a magnetoresistive ultrasonic transducer 150.

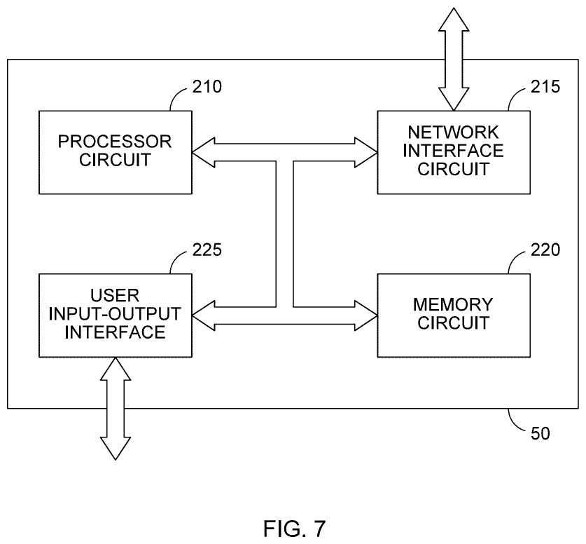

Referring to FIGS. 1-5, a representative first embodiment of a vibrational system 100 comprises one or more ultrasonic transducers 150 attached, connected, or otherwise coupled to an acoustic vibration ring 125, or more generally a vibration ring 125, with the one or more ultrasonic transducers 150 further coupled to a controller 50 via a power and control cable 160. A cylindrical portion 170 of each ultrasonic transducer 150 is inset into a corresponding transducer recess (or cavity) 115 and coupled to the vibration ring 125 by welding or brazing, or by using clamps or latches (not separately illustrated), for example and without limitation. The vibration ring 125 with the coupled ultrasonic transducers 150 are further coupled around a pipe 110 (or pipeline or pipe valve, for example and without limitation), typically in the vicinity of a distal portion 107 of a bend or elbow 105, as illustrated in FIG. 1. The controller 50 may be implemented or embodied as discussed in greater detail below with reference to FIG. 7. Not separately illustrated in the Figures, the controller 50 is typically also coupled to a power supply, such as AC line power, a battery, a photovoltaic cell, etc.

As illustrated in FIG. 1, for the vibrational system 100, the ultrasonic transducers 150 are arranged to be spaced apart in a circular pattern 130 around the exterior circumference of the pipe 110, typically distally to any bend or elbow 105 in the pipe 110. As illustrated in FIG. 3, for the vibrational system 200, a first plurality 152 of ultrasonic transducers 150 are arranged to be spaced apart in a linear pattern 132 along the lower, horizontal exterior surface of the pipe 110, also in the distal portion 107 of the bend or elbow 105. As another illustrated example in FIG. 3, a second plurality 154 of ultrasonic transducers 150 are also arranged to be spaced apart in a linear pattern 132 along a vertical exterior surface of the pipe 110, along a proximal portion 109 of the bend or elbow 105, i.e., providing ultrasonic transducers 150 on opposite sides of the elbow or bend 105. As illustrated in FIG. 4, for the vibrational system 300, the ultrasonic transducers 150 are arranged to be spaced apart in a helical or spiral pattern 134 around the exterior circumference of the pipe 110, also typically in the distal portion 107 any bend or elbow 105 in the pipe 110. Those having skill in the art will recognize that the one or more ultrasonic transducers 150 may be coupled or arrayed along a pipe 110 in a wide variety of ways, patterns, and locations, each of which is considered equivalent and within the scope of the disclosure.

In addition, the one or more ultrasonic transducers 150 may also be coupled to the pipe 110 in a wide variety of ways, in addition to or in lieu of the coupling using the illustrated vibration ring 125. As illustrated in FIG. 3, a representative second embodiment of a vibrational system 200 comprises one or more ultrasonic transducers 150 attached, connected, or otherwise coupled to an acoustical stub 120, or more generally a stub 120, with the one or more ultrasonic transducers 150 further coupled to a controller 50, also via a power and control cable 160. Each of the ultrasonic transducers 150 are coupled to a corresponding acoustical stub 120 (such as, for example and without limitation, by welding or brazing, or by using clamps or latches (not separately illustrated)), and the acoustical stubs 120 are coupled to the pipe 110 (also such as by welding or brazing, or by using clamps or latches (not separately illustrated)), also for example and without limitation. As illustrated in FIG. 4, a representative third embodiment of a vibrational system 300 comprises one or more ultrasonic transducers 150, which are then coupled directly to the pipe 110, such as by welding or brazing, or by using clamps or latches (not separately illustrated), also for example and without limitation, with the one or more ultrasonic transducers 150 further coupled to a controller 50, also via a power and control cable 160.

In operation, for each of the vibrational systems 100, 200, 300, when energized under the control of the controller 50, the ultrasonic transducers 150 generate vibrations at ultrasonic frequencies, such as between 20 kHz-20 MHz, i.e., greater than 20 kHz or greater than 1 kHz, for example and without limitation, and these ultrasonic vibrations are transmitted to the pipe 110 via the acoustical vibration ring 125 in the vibrational system 100, or via the acoustical stub 120 in the vibrational system 200, or directly to the pipe 110 in the vibrational system 300. As a result, vibrations at ultrasonic frequencies are generated in the wall 112 of the pipe 110, generally within the vicinity of the acoustical vibration ring 125, the acoustical stub 120, or the one or more ultrasonic transducers 150, and in turn, into the pipe lumen 114. These vibrations at ultrasonic frequencies have several effects. First, within the pipe 110 or other vessel, these vibrations have the effect of creating a slip surface along the interior surface 116 (of the interior circumference of the pipe 110), which serves to reduce the settling of particles within a slurry flowing through the pipe lumen 114, particularly along the distal portion 107 of the bend or elbow 105. Second, these vibrations are further transmitted to the slurry itself, which also imparts energy or motion to and serves to reduce the settling of particles of the slurry flowing through the pipe lumen 114.

Any type of kind of transducer may be utilized to create vibrations, at any suitable frequency (in addition to ultrasonic frequencies, such as magnetoresistive transducers, piezoelectric transducers, etc., for example and without limitation, and all such transducers operational at any suitable frequency are considered equivalent and within the scope of the disclosure.

A representative magnetoresistive ultrasonic transducer 150A is illustrated in FIG. 5, to provide an example of a suitable transducer 150 which may be utilized within the various systems 100, 200, 300. Such a magnetoresistive ultrasonic transducer 150A, for example, may be embodied as described in U.S. Pat. No. 7,276,824 B2 issued Oct. 2, 2007, which disclosure is incorporated herein by reference. Such a magnetoresistive ultrasonic transducer 150A is also commercially available, for example, from Applied Ultrasonics International of Sydney, Australia and Alabaster, Alabama US, www.appliedultrasonics.com.

Referring to FIG. 5, a magnetoresistive ultrasonic transducer 150A comprises an acoustical concentrator 165 coupled to a magnetoresistive core 185 having an electrical winding 190, arranged within a housing 155. The acoustical concentrator 165 comprises a conical portion 180, a zero collar 175, and a cylindrical portion 170. The magnetoresistive core 185 is energized (through the electrical winding 190 via the power and control cable 160) under the control of the controller 50, and when energized, creates vibrational energy within the acoustical concentrator 165. The cylindrical portion 170 of the acoustical concentrator 165 is utilized to transmit ultrasonic vibrations to the acoustical vibration ring 125, the acoustical stub 120, or to the pipe 110, either directly or via an acoustical waveguide (not separately illustrated).

While referred to as ultrasonic transducers 150, those having skill in the art will also recognize that the vibrations may be generated at any suitable frequencies, in addition to ultrasonic frequencies, and all such vibrational frequencies are considered equivalent and within the scope of the disclosure.

In addition, the one or more ultrasonic transducers 150 may be selected and energized under the control of the controller 50 using a wide variety of user-selectable operational parameters, including in any selected order, in any selected pattern, in any selected mode, at any selected frequency or range of frequencies and sequence of frequencies, and for any selected time duration or time period, for example and without limitation. One such user-selectable operational parameter includes the selection of the location(s) of the ultrasonic transducers 150 for energizing, such as from among a plurality of locations of ultrasonic transducers 150 which may be arrayed and available for energizing. Another such user-selectable operational parameter includes the selection of which ultrasonic transducers 150, among a plurality of ultrasonic transducers 150, are to be energized at the selected locations.

A third user-selectable operational parameter includes selecting the ordering of the energizing of these selected ultrasonic transducers 150 at the selected locations, such as an energizing of all of the selected ultrasonic transducers 150 at the same time, a sequential energizing of the selected ultrasonic transducers 150, a random or pseudo-random energizing of the selected ultrasonic transducers 150, a selected (non-sequential) ordering of the energizing of these selected ultrasonic transducers 150 (e.g. energizing a first ultrasonic transducer 150, followed by energizing a third ultrasonic transducer 150, followed by energizing a fifth ultrasonic transducer 150, followed by energizing a second ultrasonic transducer 150, and so on), for example and without limitation.

A fourth user-selectable operational parameter includes selection of the mode of the energizing of these selected ultrasonic transducers 150 at the selected locations, such as continuous energizing, pulsed energizing, or a combination of continuous and pulsed energizing, for example and without limitation, for the selected ordering of the selected ultrasonic transducers 150 at the selected location(s).

A fifth user-selectable operational parameter includes selection of the frequency or frequency range of the energizing of these selected ultrasonic transducers 150 at the selected location(s), including if and how the frequency or frequency range may be varied during energizing, such as selection of a first frequency or frequency range for the entire energizing, selection of a first frequency or frequency range for a first period of time followed by a second frequency or frequency range for a second period of time, and so on, for example and without limitation. For example, a sub-audible frequency range may be selected, followed by an ultrasonic frequency range.

Lastly, a sixth user-selectable operational parameter includes selection of the duration or time period(s) of the energizing of these selected ultrasonic transducers 150 at the selected location(s). For example, in addition to continuous operation, a user or operator of the vibrational systems 100, 200, 300 may select intermittent operations, such as selection of certain times of day, for selected durations, for selected days of the week, and do on, for the energizing of the transducers 150.

It should also be noted that each of these various operational parameters may be tested and evaluated empirically for any given or selected installation of a vibrational systems 100, 200, 300, based upon, for example, the type and size of the particles in the slurry, the type and size of the pipe or pipeline or other vessel, the kind of fluid utilized to suspend the particles, etc. The user may then determine, also for example, which operational parameter selections are optimal or otherwise most suited for the particular, applicable conditions.

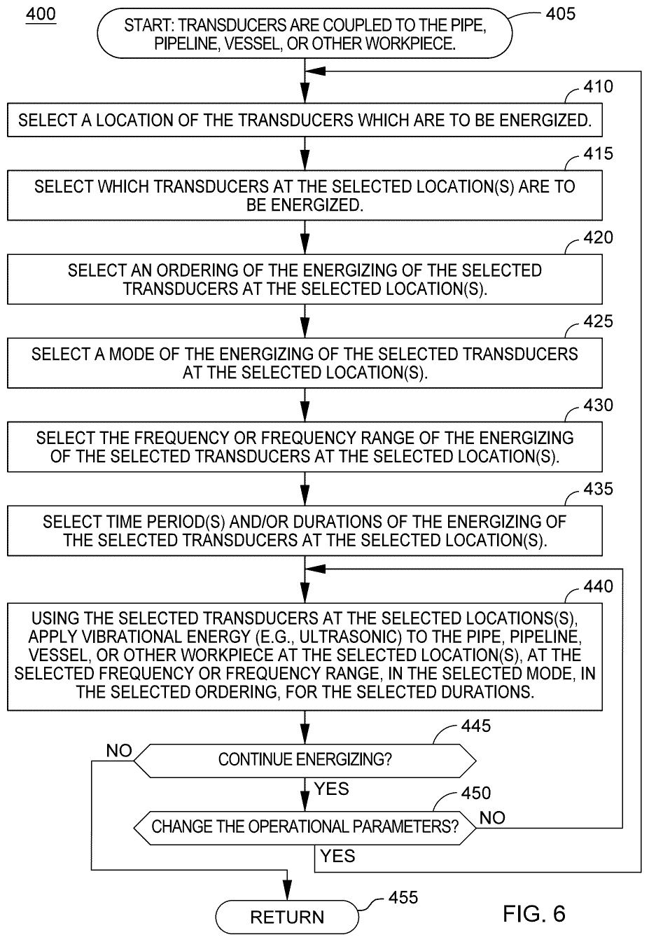

FIG. 6 is a flow chart illustrating a method 400 of providing vibration, and provides a useful summary. The method may begin, start step 405, following the coupling of the transducers 150 to the pipe, pipeline, vessel, or other workpiece. The user or operator then selects the location of the transducers 150 which are to be energized, step 410, and selects which transducers 150 at the selected location(s) are to be energized, step 415. The user or operator then selects the ordering and the mode of the energizing of the selected transducers 150 at the selected location(s), steps 420, 425. The user or operator then selects the frequency or frequency range of the energizing of the selected transducers 150 at the selected location(s), step 430. The user or operator then selects the time period(s) and/or durations of the energizing of the selected transducers 150 at the selected location(s), step 435.

It should be noted that the various operational parameter selection steps (410-435) may occur in a wide variety of orders, and all such orderings are considered equivalent and within the scope of the disclosure. It should also be noted that these various operational parameter selections may be different for each transducer 150 at any location, e.g., one transducer 150 may be pulsed while another transducer 150 may be energized continuously; one transducer 150 may be energized at a first frequency range while another transducer 150 may be energized at a second frequency range, etc., for example and without limitation

Following this selection of operational parameters, using the selected transducers 150 at the selected location(s), in step 440, the vibrational energy (e.g., ultrasonic) is applied to the pipe, pipeline, vessel, or other workpiece at the selected location(s), at the selected frequency or frequency range, in the selected mode, in the selected ordering, for the selected durations. When the energizing of the transducers 150 is to continue, step 445, the method proceeds to determine whether the operational parameters are to be changed or altered, step 450, and is so, the method returns to step 410, and when the parameters are to remain the same, the method returns to step 440, to continue with the selected energizing. When the energizing of the transducers 150 is completed, step 445, the method may end, return step 455.

FIG. 7 is an electronic block diagram illustrating a representative embodiment of a controller 50 of the representative first, second, or third embodiments of the vibrational system 100, 200, 300. Referring to FIG. 7, the exemplary controller 50 comprises one or more processor(s) 210, a network input/output (“I/O”) interface 215, and a memory 220 (such as a random access memory (RAM) or the other forms of memory 220 described below, such as DRAM, SDRAM, etc., which also may include one or more databases). Depending upon the selected embodiment, the controller 50 may also include optional components such as a user input/output (“I/O”) interface 225 (such as for coupling to a user input device such as a keyboard, computer mouse, or other user input device, not separately illustrated). The processor(s) 210, network input/output (“I/O”) interface 215, memory 220, and user input/output (“I/O”) interface 225 may be implemented or embodied as known or becomes known in the electronic arts, such as for appropriate connections to user input and output devices, such as a keyboard, a mouse, a trackball, a visual display, etc. The processor 215 is structured or otherwise programmed to process instructions within the system 100, 200, 300. In various embodiments, the processor 210 is a single-threaded processor or may be a multi-threaded processor, and may have a single processing core or multiple processing cores (not separately illustrated). The processor 210 is structured or otherwise programmed generally to process instructions stored in the memory 220 (or other memory and/or a storage device) to control the energizing of the ultrasonic transducer 150 based upon the user-selectable parameters described above, including in any selected order, in any selected pattern, in any selected mode, and at any selected frequency or range of frequencies and sequence of frequencies, for example and without limitation.

As used herein, a processor 210 may be implemented using any type of digital or analog electronic or other circuitry which is arranged, configured, designed, programmed or otherwise adapted to perform the control of the ultrasonic transducer 150 described herein, such as the energizing, frequency, pattern and mode, as discussed above. As the term processor is used herein, a processor 210 may include use of a single integrated circuit (“IC”), or may include use of a plurality of integrated circuits or other electronic components connected, arranged or grouped together, such as processors, controllers, microprocessors, digital signal processors (“DSPs”), parallel processors, multiple core processors, custom ICs, application specific integrated circuits (“ASICs”), field programmable gate arrays (“FPGAs”), adaptive computing ICs, discrete electronic components, and any associated memory (such as RAM, DRAM and ROM), and other ICs and components, whether analog or digital. As a consequence, as used herein, the term processor should be understood to equivalently mean and include a single IC, or arrangement of custom ICs, ASICs, processors, microprocessors, controllers, FPGAs, adaptive computing ICs, or some other grouping of integrated circuits or discrete electronic components which perform the functions discussed above and further discussed below, and may further include any associated memory, such as microprocessor memory or additional RAM, DRAM, SDRAM, SRAM, MRAM, ROM, FLASH, EPROM or E2PROM. A processor (such as processor 210), with any associated memory, may be arranged, adapted or configured (via programming, FPGA interconnection, or hard-wiring) to perform the control of the ultrasonic transducer 150, as described herein. For example, the methodology may be programmed and stored, in a processor 210 with its associated memory (and/or memory 220) and other equivalent components, as a set of program instructions or other code (or equivalent configuration or other program) for subsequent execution when the processor 210 is operative (i.e., powered on and functioning). Equivalently, when the processor 210 may implemented in whole or part as FPGAs, custom ICs and/or ASICs, the FPGAs, custom ICs or ASICs also may be designed, configured and/or hard-wired to implement the control of the ultrasonic transducer 150 of the present disclosure. For example, the processor 210 may be implemented as an arrangement of analog and/or digital circuits, controllers, microprocessors, DSPs and/or ASICs, collectively referred to as a “processor”, which are respectively hard-wired, arranged, programmed, designed, adapted or configured to implement the control of the ultrasonic transducer 150 of the present disclosure, including possibly in conjunction with a memory 220.

A memory 220 may be embodied as any type of data storage device, such as RAM, FLASH, DRAM, SDRAM, SRAM, MRAM, FeRAM, ROM, EPROM or E2PROM, and is utilized for data storage, and also may be utilized to store any program instructions or configurations which may be utilized by a processor 210. More specifically, the memory 220 may be embodied in any number of forms, including within any nontransitory, machine-readable data storage medium, memory device or other storage or communication device for storage or communication of information, currently known or which becomes available in the future, including, but not limited to, a memory integrated circuit (“IC”), or memory portion of an integrated circuit (such as the resident memory within a processor 210), whether volatile or non-volatile, whether removable or non-removable, including without limitation RAM, FLASH, DRAM, SDRAM, SRAM, MRAM, FeRAM, ROM, EPROM or E2PROM, or any other form of memory or data storage device, such as a magnetic hard drive, an optical drive, a magnetic disk or tape drive, a hard disk drive, other machine-readable storage or memory media such as a floppy disk, a CDROM, a CD-RW, digital versatile disk (DVD) or other optical memory, or any other type of memory, storage medium, or data storage apparatus or circuit, which is known or which becomes known, depending upon the selected embodiment. The memory 220 may store data in any way or configuration, including as various look up tables, parameters, coefficients, databases, other information and data, programs or instructions (of the software of the present invention), and other types of tables such as database tables or any other form of data repository.

The network interface (I/O) circuit 215 may be implemented as known or may become known in the art, and may include impedance matching capability, voltage rectification circuitry, voltage translation for a low voltage processor to interface with a higher voltage control bus for example, various switching mechanisms (e.g., transistors) to turn various lines or connectors on or off in response to signaling from a processor 210, other control logic circuitry, and/or physical coupling mechanisms. In addition, the network interface (I/O) circuit 215 is also adapted to receive and/or transmit signals externally to the controller 50, respectively, such as through hard-wiring or RF signaling, for example, to receive and transmit information in real-time, such as control or operational parameters discussed above, also for example. The network interface (I/O) circuit 215 also may be stand-alone devices (e.g., modular). The network interface (I/O) circuit 215 is utilized for appropriate connection to a relevant channel, network or bus; for example, the network interface (I/O) circuit 215 may provide impedance matching, drivers and other functions for a wireline interface, may provide demodulation and analog to digital conversion for a wireless interface, and may provide a physical interface for the memory 220 with other devices. In general, the network interface (I/O) circuits 215 is used to receive and transmit data, depending upon the selected embodiment, such as the control or operational parameters described above.

As indicated above, the processor 210 is hard-wired, configured or programmed, using software and data structures of the invention, for example, to control the ultrasonic transducer 150. As a consequence, the control portions of the system and method of the present disclosure may be embodied as software which provides such programming or other instructions, such as a set of instructions and/or metadata embodied within a nontransitory computer-readable medium, discussed above. Such software may be in the form of source or object code, by way of example and without limitation. Source code further may be compiled into some form of instructions or object code (including assembly language instructions or configuration information). The software, source code or metadata of the present invention may be embodied as any type of code, such as C, C++, Javascript, Adobe Flash, Silverlight, SystemC, LISA, XML, Java, Brew, SQL and its variations (e.g., SQL 99 or proprietary versions of SQL), DB2, Oracle, or any other type of programming language which performs the functionality discussed herein, including various hardware definition or hardware modeling languages (e.g., Verilog, VHDL, RTL) and resulting database files (e.g., GDSII). As a consequence, “software”, “program”, “computer program”, or a “module”, “program module”, “software module”, as used equivalently herein, means and refers to any programming language, of any kind, with any syntax or signatures, which provides or can be interpreted to provide the associated functionality or methodology specified (when instantiated or loaded into a processor or computer and executed, including the processor 210, for example). In addition, any of such program or software modules may be combined or divided in any way. For example, a larger module combining first and second functions is considered equivalent to a first module which performs the first function and a separate second module which performs the second function.

Numerous advantages of the exemplary or representative embodiments of the present invention are readily apparent. Various representative embodiments provide a vibrational system and method to reduce settling of particles in a flowing slurry, thereby reducing or eliminating the obstruction of the pipes, pipelines, holding tanks, pipe valves, other containers. The representative embodiments of the vibrational system are capable of operating during the flow of the slurry without requiring interruption or halting of the production process, and without requiring the introduction of caustic chemicals into the pipe, pipeline, holding tank, pipe valve, or other container. The representative embodiments of the vibrational system also are capable of installation and operation in existing commercial facilities.

The present disclosure is to be considered as an exemplification of the principles of the invention and is not intended to limit the invention to the specific embodiments illustrated. In this respect, it is to be understood that the invention is not limited in its application to the details of construction and to the arrangements of components set forth above and below, illustrated in the drawings, or as described in the examples. Systems, methods and apparatuses consistent with the present invention are capable of other embodiments and of being practiced and carried out in various ways.

Although the invention has been described with respect to specific embodiments thereof, these embodiments are merely illustrative and not restrictive of the invention. In the description herein, numerous specific details are provided, such as examples of electronic components, electronic and structural connections, materials, and structural variations, to provide a thorough understanding of embodiments of the present invention. One skilled in the relevant art will recognize, however, that an embodiment of the invention can be practiced without one or more of the specific details, or with other apparatus, systems, assemblies, components, materials, parts, etc. In other instances, well-known structures, materials, or operations are not specifically shown or described in detail to avoid obscuring aspects of embodiments of the present invention. In addition, the various Figures are not drawn to scale and should not be regarded as limiting.

Reference throughout this specification to “one embodiment”, “an embodiment”, or a specific “embodiment” means that a particular feature, structure, or characteristic described in connection with the embodiment is included in at least one embodiment of the present invention and not necessarily in all embodiments, and further, are not necessarily referring to the same embodiment. Furthermore, the particular features, structures, or characteristics of any specific embodiment of the present invention may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

It will also be appreciated that one or more of the elements depicted in the Figures can also be implemented in a more separate or integrated manner, or even removed or rendered inoperable in certain cases, as may be useful in accordance with a particular application. Integrally formed combinations of components are also within the scope of the invention, particularly for embodiments in which a separation or combination of discrete components is unclear or indiscernible. In addition, use of the term “coupled” herein, including in its various forms such as “coupling” or “couplable”, means and includes any direct or indirect electrical, structural or magnetic coupling, connection or attachment, or adaptation or capability for such a direct or indirect electrical, structural or magnetic coupling, connection or attachment, including integrally formed components and components which are coupled via or through another component.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated. In addition, every intervening sub-range within range is contemplated, in any combination, and is within the scope of the disclosure. For example, for the range of 5-10, the sub-ranges 5-6, 5-7, 5-8, 5-9, 6-7, 6-8, 6-9, 6-10, 7-8, 7-9, 7-10, 8-9, 8-10, and 9-10 are contemplated and within the scope of the disclosed range.

Furthermore, any signal arrows in the drawings/Figures should be considered only exemplary, and not limiting, unless otherwise specifically noted. Combinations of components of steps will also be considered within the scope of the present invention, particularly where the ability to separate or combine is unclear or foreseeable. The disjunctive term “or”, as used herein and throughout the claims that follow, is generally intended to mean “and/or”, having both conjunctive and disjunctive meanings (and is not confined to an “exclusive or” meaning), unless otherwise indicated. As used in the description herein and throughout the claims that follow, “a”, “an”, and “the” include plural references unless the context clearly dictates otherwise. Also as used in the description herein and throughout the claims that follow, the meaning of “in” includes “in” and “on” unless the context clearly dictates otherwise.

The foregoing description of illustrated embodiments of the present invention, including what is described in the summary or in the abstract, is not intended to be exhaustive or to limit the invention to the precise forms disclosed herein. From the foregoing, it will be observed that numerous variations, modifications and substitutions are intended and may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

1. A system for coupling to a pipe, pipeline, vessel, holding tank, valve, container, or other workpiece, the system comprising:
one or more transducers coupleable to the pipe, pipeline, vessel, holding tank, valve, container, or other workpiece; and
a controller coupled to the one or more transducers, the controller comprising:
a memory circuit configured to store a plurality of operational parameters; and
a processor circuit coupled to the memory circuit, the processor circuit configured to control energizing of the one or more transducers in response to the plurality of operational parameters.

2. The system of claim 1, further comprising:
a coupling ring or coupling stub coupled to the plurality of transducers and coupleable to the pipe, pipeline, vessel, holding tank, valve, container, or other workpiece.

3. The system of claim 1, wherein the one or more transducers are each operable in an ultrasonic frequency range greater than or equal to 20 kHz.

4. The system of claim 1, wherein the one or more transducers are each operable in a frequency range from 1 kHz to 20 MHz.

5. The system of claim 1, wherein a first operational parameter of the plurality of operational parameters comprises a frequency or frequency range.

6. The system of claim 5, wherein a second operational parameter of the plurality of operational parameters comprises a location of the plurality of transducers.

7. The system of claim 6, wherein a third operational parameter of the plurality of operational parameters comprises a selection of a transducers of the one or more transducers.

8. The system of claim 7, wherein a fourth operational parameter of the plurality of operational parameters comprises an ordering of energizing of the one or more transducers.

9. The system of claim 8, wherein the ordering of the energizing of the one or more transducers comprises one or more orderings selected from the group consisting of: a sequential ordering, a random or pseudo-random ordering, a non-sequential ordering, and combinations thereof.

10. The system of claim 8, wherein a fifth operational parameter of the plurality of operational parameters comprises a mode of energizing of the one or more transducers.

11. The system of claim 10, wherein the mode of the energizing of the one or more transducers comprises one or more modes selected from the group consisting of: continuous energizing, pulsed energizing, and combinations thereof.

12. The system of claim 10, wherein a sixth operational parameter of the plurality of operational parameters comprises a duration or time period of energizing of the one or more transducers.

13. The system of claim 1, wherein one or more transducers of the plurality of transducers comprises a transducer selected from the group consisting of: a magnetoresistive transducer, a piezoelectric transducer, a mutual induction transducer, an electromagnetic transducer, a Hall Effect transducer; and combinations thereof.

14. A method of fabricating the system of claim 1, the method comprising:
coupling the one or more transducers to the pipe, pipeline, vessel, or other workpiece;
coupling the controller to the one or more transducers; and
coupling the controller to a power supply.

15. The method of claim 14, further comprising:
coupling a coupling ring, a coupling stub, or a pipe stub to the pipe, pipeline, vessel, or other workpiece;
wherein the step of coupling the one or more transducers to the pipe, pipeline, vessel, or other workpiece further comprises:
coupling the one or more transducers to the coupling ring, coupling stub or the pipe stub.

16. A method of reducing obstruction formation in a pipe, pipeline, holding tank, valve, or other container, using a plurality of transducers coupled to the pipe, pipeline, holding tank, valve, or other container, the method comprising:
selecting one or more operational parameters of a plurality of operational parameters; and
energizing one or more transducers of the plurality of transducers in response to the selected operational parameters.

17. The method of claim 16, wherein the plurality of transducers are each operable in an ultrasonic frequency range greater than or equal to 20 KHz.

18. The method of claim 16, wherein the plurality of transducers are each operable in an ultrasonic frequency range from 1 kHz to 20 MHz.

19. The method of claim 16, wherein the plurality of operational parameters comprises at least two operational parameters selected from the group consisting of: a frequency or frequency range; a location of the plurality of transducers; a selection of one or more transducers of the plurality of transducers; a sequential ordering of energizing of the plurality of transducers; a random or pseudo-random ordering of energizing of the plurality of transducers; a non-sequential ordering of energizing of the plurality of transducers; a continuous mode of energizing of the plurality of transducers; a pulsed mode of energizing of the plurality of transducers; a duration or time period of energizing of the plurality of transducers; and combinations thereof.

20. The method of claim 16, wherein one or more transducers of the plurality of transducers comprises a transducer selected from the group consisting of: a magnetoresistive transducer, a piezoelectric transducer, a mutual induction transducer, an electromagnetic transducer, a Hall Effect transducer; and combinations thereof.

21. A method of reducing obstruction formation in a pipe, pipeline, holding tank, valve, or other container, using a plurality of transducers coupled to the pipe, pipeline, holding tank, valve, or other container, the method comprising:
selecting a location of one or more transducers of the plurality of transducers for energizing;
selecting one or more transducers of the plurality of transducers for energizing at the selected location;
selecting an ordering of energizing of the selected one or more transducers at the selected location;
selecting a mode of energizing of the selected one or more transducers at the selected location;
selecting a frequency or frequency range of energizing of the selected one or more transducers at the selected location;
selecting duration of energizing of the selected one or more transducers at the selected location; and
energizing the one or more transducers at the selected location according to the selected order, mode, frequency or frequency range, and duration.
